(19) United States
(12) Patent Application Publication
(10) Pub. No.: US 2025/0130858 A1
(43) Pub. Date: Apr. 24, 2025

(54) AUTOSTALER FOR PERSISTING CLOUD COMPUTING INSTANCES

(71) Applicant: Ancestry.com DNA, LLC, Lehi, UT (US)

(72) Inventors: Chaz Reid, San Francisco, CA (US); Luiz Irber, San Francisco, CA (US); Richard Lee Olpin, San Francisco, CA (US)

(21) Appl. No.: 18/923,381

(22) Filed: Oct. 22, 2024

Related U.S. Application Data
(60) Provisional application No. 63/592,278, filed on Oct. 23, 2023.

(51) Int. Cl. G06F 9/50

(52) U.S. Cl. CPC G06F 9/5027

(57) ABSTRACT

The present disclosure is directed toward systems, methods, and non-transitory computer-readable media for providing an autostaler mechanism that is purpose-built to prevent cloud computing systems from terminating certain processes or instances that would otherwise be terminated by autoscaling mechanisms. Specifically, the autostaler determines various criteria or parameters associated with a compute instance and further determines a state for the compute instance based on the parameters. For example, the autostaler designates a stale state for an instance based on determining computational requirements for the instance and/or based on comparing processes of the instance with a custom process list that defines processes which are stale-able and/or not stale-able. Indeed, the autostaler can designate a process that would otherwise be terminated by a cloud computing system as stale to persist the process and prevent its termination.

### CROSS-REFERENCE TO RELATED APPLICATIONS

The present application claims priority to, and the benefit of, U.S. Provisional Application No. 63/592,278, titled AUTOSTALER FOR PERSISTING CLOUD COMPUTING PROCESSES, filed on Oct. 23, 2023. The aforementioned application is hereby incorporated by reference in its entirety.

### BACKGROUND

Advancements in computing devices and networking technology have given rise to a variety of innovations in cloud-based computing and distributed processing. For example, cloud computing systems can execute processes initialized at local devices by determining computational requirements and scaling network computing resources to meet the needs of each process. To facilitate such functionality, modern cloud computing systems can spin up and utilize virtual machines that execute or run instances of individual processes independently and/or as part of an overarching program. Despite these advances, however, existing cloud computing systems continue to suffer from a number of disadvantages, particularly in terms of accuracy, data integrity, and efficiency.

As just suggested, certain existing cloud computing systems inaccurately determine computing resources for some processes or machine instances. To elaborate, many cloud computing systems utilize autoscaling mechanisms that monitor the compute load (e.g., CPU usage and/or memory usage) of processes on various virtual machines or instances. Using these autoscaling mechanisms, existing systems automatically scale (e.g., spin up or spin down) network resources across various virtual machines (operated at cloud servers) to run the process. As part of this resource management, autoscaling mechanisms often identify processes or instances to terminate, such as instances that utilize very little processing power and/or memory as an indicator that they are idle or inactive instances (e.g., to free up processing capacity for other processes and/or to clean up processes that have completed but continue tying up computing resources). However, many existing autoscaling mechanisms inaccurately terminate instances that should not be terminated, even if they are still idle instances and/or they are instances that consume relatively little computing resources. For instance, some instances are computationally light but require execution over long periods of time (e.g., hours, days, or weeks) to complete. Left to their own devices, many existing systems erroneously terminate such small instances based on a determination that they are idle and/or inactive, having been running for a long time with consistently low usage.

Due at least in part to their inaccurate determinations to terminate certain instances, some existing systems compromise the data integrity of instances executed by virtual machines within such systems. Specifically, many client devices, such as workstations operated by data scientists or researchers, generate or instantiate low-expense instances that are nevertheless vital to the accurate execution of an overarching program or computational model/experiment. In these cases, existing systems often compromise the integrity of—and even the overall functionality and purpose behind—computational models that rely on instances which spin up relatively little computing resources and which are therefore terminated by autoscaling mechanisms.

In addition to their accuracy and data integrity concerns, some existing cloud computing are also inefficient. For example, as a result of terminating instances that should be kept alive, existing systems often re-run redundant instances of the same instances repeatedly as workstations initiate repeat requests. In addition, to prevent instances from terminating, some existing systems artificially inflate the processing requirements of the instances (or process are running on instances) by adding additional instances or functions to appear more processing-intensive. Thus, some existing systems consume excessive amounts of computing resources, such as processing power and memory, that could otherwise be preserved with a more efficient system.

### SUMMARY

This disclosure describes one or more embodiments of systems, methods, and non-transitory computer-readable storage media that provide benefits and/or solve one or more of the foregoing and other problems in the art. In particular, the disclosed systems provide an autostaler mechanism that is purpose-built to prevent cloud computing systems from terminating certain processes or instances that would otherwise be terminated by autoscaling mechanisms. Specifically, the autostaler determines various criteria or parameters associated with an instance and further determines a state for the instance based on the criteria/parameters. For example, the autostaler designates a state for an instance based on determining computational requirements for the instance and/or based on comparing the process with a custom process list that defines instances which are stale-able and/or not stale-able. Indeed, the autostaler can designate an instance that would otherwise be terminated by a cloud computing system as stale to persist the process and prevent its termination.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which an autostaler system operates in accordance with one or more embodiments.

FIG. 2 illustrates an example overview of determining compute instances to designate as stale in accordance with one or more embodiments.

FIG. 3 illustrates an example diagram of determining computing resources associated with compute instances in accordance with one or more embodiments.

FIG. 4 illustrates an example diagram of updating parameters for designated compute instances as stale in accordance with one or more embodiments.

FIG. 5 illustrates an interface including a stale instance notification in accordance with one or more embodiments.

FIG. 6 an example series of acts for designating a compute instance as stale in accordance with one or more embodiments.

FIG. 7 illustrates an example series of acts for designating a compute instance as stale in accordance with one or more embodiments.

FIG. 8 illustrates a block diagram of an example computing device for implementing one or more embodiments of the present disclosure.

FIG. 9 illustrates an example environment of a networking system having the autostaler system in accordance with one or more embodiments.

### DETAILED DESCRIPTION

This disclosure describes one or more embodiments of an autostaler system that can automatically (e.g., without intervention or input from a user or a device) designate compute instances and/or processes as stale to preserve their operation on a cloud computing system. In certain use cases, client devices instantiate cloud-executed compute instances as part of a computer program or a computational model, where a compute instance is made up of one or more virtual machines executing processes that together accomplish or generate an output of the program or model. As part of this process, the autostaler system can run an autostaling script (e.g., a code segment defining an instance of an autostaler program/application) locally at a client device (and/or at a cloud server), such as a workstation operated by a data scientist or a researcher, that generates and requests operation of a computational model at a cloud computing system. In executing the autostaling script, the autostaler system can analyze individual compute instances (and/or processes running on compute instances) within the computational model to determine respective states. In some cases, the autostaler system can further designate a compute instance state as stale where the cloud computing system would otherwise terminate the instance that should nevertheless persist in operation on one or more virtual machines. The autostaler system thus communicates with the cloud computing system to prevent termination of stale processes.

To determine states for compute instances, the autostaler system can extract or determine features, metrics, or parameters associated with the compute instance. For example, the autostaler system can analyze a compute instance and its execution and distribution on a cloud computing system to determine its computational expense (e.g., processor/CPU usage, memory usage, number of assigned virtual machines, and/or processing time). In some cases, the autostaler system determines additional features or parameters, such as an indication (e.g., a binary flag) of whether a compute instance is running processes found within a custom process list that defines processes that are stale-able and/or not stale-able.

Based on determining the metrics, features, or parameters for a compute instance, the autostaler system can further determine a state for the compute instance. For instance, the autostaler system can designate one of three states for a given compute instance: i) active or currently running (e.g., in satisfaction of minimum processing requirements of a scaling mechanism of a cloud computing system), ii) idle and ready for termination, or iii) stale. Existing cloud computing systems generally consider only the first two states for a compute instance and do not have a function for defining stale compute instances, much less for preventing termination of compute instances defined as stale. The autostaler system, by contrast, can designate a compute instance as stale even if the instance would otherwise be terminated by the cloud computing system for failing to satisfy one or more computational thresholds, thereby causing the cloud computing system to persist the instance instead.

As suggested above, the autostaler system can provide improvements or advantages over existing cloud computing systems. For example, the autostaler system can improve accuracy over prior systems in determining or designating which compute instances running on a cloud computing system to terminate and which to persist. While some existing systems utilize autoscaling mechanisms which scale cloud computing resources on a per-process or per-instance basis and which sometimes result in trimming or terminating instances that should not be terminated, the autostaler system further implements an autostaling mechanism to work in conjunction with the autoscaling mechanism. Indeed, the autostaler can designate stale compute instances to therefore persist instances that an autoscaling mechanism might otherwise designate as idle and ready for termination for failing to satisfy load thresholds for processing and/or memory usage. As described herein, the autostaler system utilizes a custom process list and/or adaptive resource thresholds to determine stale compute instances (and to therefore prevent their termination). Thus, the autostaler system can more accurately preserve even small compute instances that are running either standalone processes or that are part of larger applications, programs, or computer models.

Due at least in part to improving the accuracy of determining which compute instances to persist and which to terminate, the autostaler system can further improve data integrity over prior systems as well. To elaborate, unlike some existing systems that compromise (or entirely destroy) the operation or function of an application or a computational model by terminating smaller individual compute instances that are part of (or work in conjunction with) the application/model, the autostaler system preserves the integrity and operation of such applications/models. For example, the autostaler system prevents termination of certain compute instances (e.g., those marked as stale) based on comparing processes or compute instances with a custom process list and/or based on adaptive resource thresholds (e.g., computing resource thresholds that adapt on a per-instance basis).

In addition to improving accuracy and data integrity, the autostaler system can also improve computational efficiency over prior systems. More specifically, the autostaler system can reduce the amount of processing power and memory consumed in executing certain compute instances on a cloud computing system compared to some existing systems. For example, rather than repeatedly running redundant compute instances, the autostaler system can persist a single inexpensive compute instances on a virtual machine without terminating it. In addition, while some prior systems artificially inflate the processing load of compute instances to keep them running, the autostaler system need not increase processing cost, instead using the described staling functionality that preserves inexpensive compute instances and prevents their termination. Indeed, experimenters have demonstrated the reduction in computational expense of the autostaler system compared to prior systems that cannot automatically mark compute instances as stale to preserve them. Some experiments yielded computational improvements of 50% or more compared to previous systems that kept processes alive using other means or that required re-running redundant compute instances after they were terminated.

As illustrated by the foregoing discussion, the present disclosure utilizes a variety of terms to describe features and benefits of the autostaler system. Additional detail is hereafter provided regarding the meaning of these terms as used in this disclosure. Additionally, while some embodiments of the autostaler system relate to the context of genealogical data and genealogical content items, the autostaler system can perform the processes described herein on other data as well. Accordingly, this disclosure is not limited to genealogical data but is extendable to other domains.

As used herein, the term “compute instance” (or sometimes simply “instance”) refers to a virtualized computing resource (or set of cloud computing resources) that provides processing power, memory, and storage to run applications, services, or workloads in a cloud computing system. A compute instance can refer to a set of one or more virtual machines with its own dedicated operating system separate from other compute instances in the cloud computing system and can be dedicated to jointly running one or more processes or applications. In some embodiments, a compute instance is scalable and launchable on demand and can operate in a virtualized environment customized according to a particular function, process, or workstation interfacing with the instance.

As used herein, the term “process” refers to a computer operation on digital data executed or performed by one or more processors (e.g., CPUs, GPUs, or FPGAs) associated with a compute instance. For example, a process includes a computer operation performed by a processor on a server as part of a cloud computing system and/or controlled by a virtual machine within the cloud computing system. Some processes are standalone process while others are part of overarching computer programs, applications, or computational models that include many separate processes which may be performed by the same processor or different processors in a distributed fashion within a cloud computing system (e.g., at different virtual machine instances). In some cases, a process involves analyzing, or executing computer operations on, computer data specifically pertaining to genealogical content, such as DNA records and genomic sequencing data (e.g., as obtained by performing genomic analysis on a genetic sample) including genotype call data (e.g., including variant calls) indicating various genotypes (and/or phenotypes) for genomic samples (e.g., samples obtained from organisms and passed through a sequencer to generate reads and corresponding genotype calls).

As mentioned, in some embodiments, a process is initiated by a client device such as a workstation operated or controlled by a data scientist or a researcher. As used herein, the term “workstation” refers to a computing device specifically designed for technical or scientific applications. For example, a workstation includes a computing device with at least one processor that analyzes or performs processes on data, such as DNA records and/or genomic sequencing data such as genotyping data. In some cases, a workstation also or alternatively initiates various computational models (run completely or partially on a cloud computing system) that includes machine learning models for generating predictions or other outputs in relation to DNA records, genomic sequencing data, newspaper images, genealogical tree data indicating relationships between individuals, and/or other genealogical data.

In addition, as used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. In some embodiments, the morphing interface system utilizes a large language machine learning model in the form of a neural network.

Relatedly, as used herein, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., search intent and/or content items) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, a diffusion neural network, or a generative adversarial neural network.

In addition, as used herein, the term “cloud computing system” refers to a distributed computing system that includes one or more servers hosting compute instances with processors for executing processes initiated at workstations (or other client devices) and which communicate (amongst themselves and with client devices) over a network. A cloud computing system can include machine learning components, applications, and scripts that assist or facilitate execution of various processes by, for example, determining computing resources to allocate for processes, modifying resources over time as processing requirements fluctuate, terminating processes that reach a maximum (or threshold) lifespan and/or that have gone idle (as indicated by CPU usage and/or memory usage). Example cloud computing systems include AMAZON WEB SERVICES (“AWS”), MICROSOFT AZURE, GOOGLE CLOUD PLATFORM, and IBM CLOUD.

As mentioned, in some embodiments, the autostaler system utilizes a cloud computing system that spins up compute instances on virtual machines to govern or run processes instantiated by client devices. As used herein, the term “virtual machine” (or sometimes simply “machine”) refers to a virtualized, digital version or model of a physical computing device, such as a server that includes processors and memory. In some cases, a single virtual machine executes or facilitates a single compute instance while in other cases, multiple virtual machines work together to facilitate a compute instance. For example, a virtual machine can execute processes using processing, storage, and memory components of distributed servers in different physical locations (communicating over a network) working together to form a single machine that acts as its own computer or entity. A single cloud computing system can generate and facilitate many virtual machines simultaneously, where each instance of a virtual machine operates independently of (but perhaps in communication with) the others, with assigned (and adaptive) processing, storage, and memory components from servers of the cloud computing system.

As also mentioned, the autostaler system can designate a compute instance as stale to preserve or persist the process when it would otherwise be terminated by a cloud computing system. As used herein, the term “stale” refers to a state of a compute instance or a computer process that would otherwise be terminated by a cloud computing system for failing to meet one or more computer resource thresholds but that is marked for preservation to prevent its termination. For example, a stale compute instance includes a compute instance that is idle in that it requires less than a threshold amount of processing power and/or memory (for at least a threshold period of time) but that is running one or more processes not found in a custom process list indicating processes that are terminatable. In some cases, a custom process list indicates processes that are terminatable (e.g., not stale-able) while in other cases, a custom process list indicates processes that are not terminatable (e.g., stale-able).

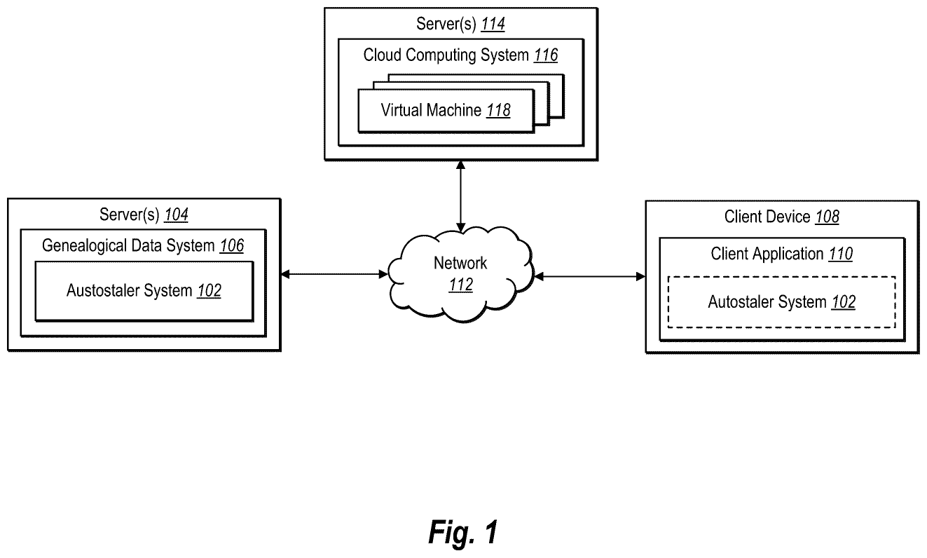

Additional detail regarding the autostaler system will now be provided with reference to the figures. For example, FIG. 1 illustrates a schematic diagram of an example system environment for implementing an autostaler system 102 in accordance with one or more implementations. An overview of the autostaler system 102 is described in relation to FIG. 1. Thereafter, a more detailed description of the components and processes of the autostaler system 102 is provided in relation to the subsequent figures.

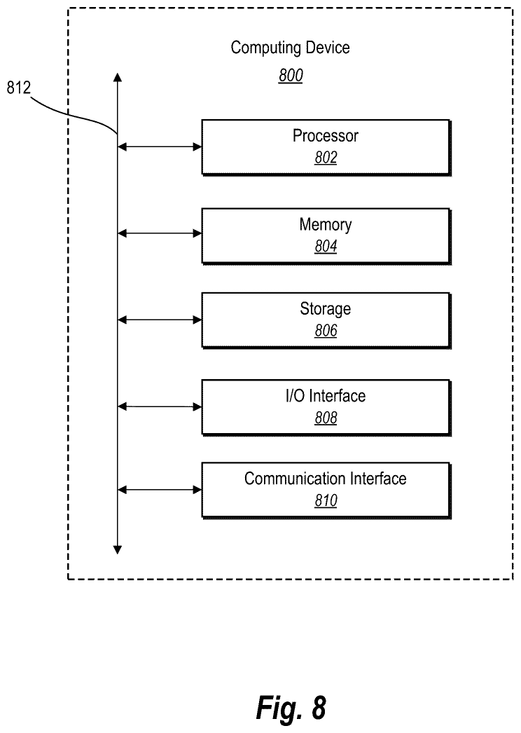

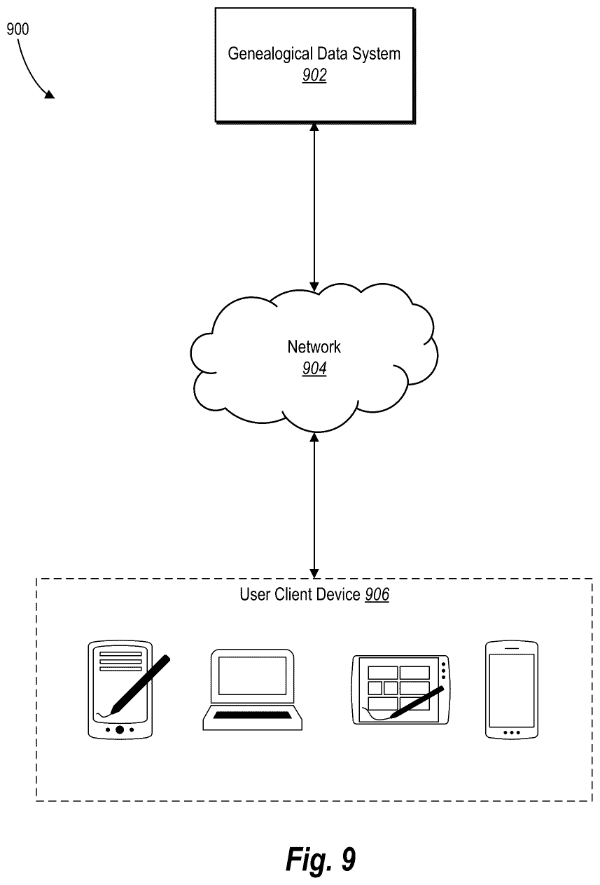

As shown, the environment includes server(s) 104, a client device 108, server(s) 114, and a network 112. Each of the components of the environment can communicate via the network 112, and the network 112 may be any suitable network over which computing devices can communicate. Example networks are discussed in more detail below in relation to FIGS. 8-9.

As mentioned above, the example environment includes a client device 108. The client device 108 can be one of a variety of computing devices, including a workstation, a smartphone, a tablet, a smart television, a desktop computer, a laptop computer, a virtual reality device, an augmented reality device, or another computing device as described in relation to FIGS. 8-9. The client device 108 can communicate with the server(s) 104 and/or the server(s) 114 via the network 112. For example, the client device 108 can receive user input from respective users interacting with the client device 108 (e.g., via the client application 110) to, for instance, instantiate a compute instance (as part of an application or a computational model) for analyzing or operating on data within the genealogical data system 106 (e.g., genomic sequencing data such as genotyping data). In addition, the autostaler system 102 on the server(s) 104 can receive information relating to various compute instance initiated based on the input received by the client device 108.

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including a user interface for setting up and running computational models for analyzing genomic data for various samples within the genealogical data system 106.

As illustrated in FIG. 1, the example environment also includes the server(s) 104. The server(s) 104 may generate, track, store, process, receive, and transmit electronic data, such as compute instances, processes, computing resource data, timing data for process runtime, and/or a custom process list. For example, the server(s) 104 may receive data from the client device 108 in the form of an indication of a selection to initiate a process for execution on the cloud computing system 116. In addition, the server(s) 104 can transmit data to the client device 108 in the form of a result or output generated by a compute instance (e.g., for display within a graphical user interface). Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, cloud-computing servers, genealogical data servers, application servers, communication servers, web-hosting servers, machine learning server, and other types of servers.

As shown in FIG. 1, the server(s) 104 can also include the autostaler system 102 as part of a genealogical data system 106. The genealogical data system 106 can communicate with the client device 108 to perform various functions associated with the client application 110 such as managing user accounts, managing genealogical data, managing genomic sequencing data, managing genealogy trees, managing genealogical content items, and facilitating user interaction with, analysis, and/or sharing of, genomic sequencing data, genealogy trees, and/or genealogical content items. Indeed, the genealogical data system 106 can include a network-based cloud storage system to generate, manage, store, and maintain genomic sequencing data for various samples associated with user accounts and/or to generate, manage, store, and maintain genealogical content items and genealogy trees (for related user accounts). For instance, the genealogical data system 106 can generate and store genomic sequencing data such as genotyping data for user accounts, indicating various propensities and probabilities for biological traits and conditions (i.e. phenotypes), as well as relationships between individuals, geographic regions, and/or other information. In addition, the genealogical data system 106 can utilize genealogical data across various content items and user accounts to generate and maintain a universal genealogy tree that reflects the relatedness or consanguinity between nodes corresponding to all user accounts and other individuals indicated by stored genealogical content items. In some embodiments, the autostaler system 102 and/or the genealogical data system 106 utilize a database to store and access information such as genomic sequencing data, genealogical content items, genealogy trees, user account data, and/or other information.

Although FIG. 1 depicts the autostaler system 102 located on the server(s) 104, in some implementations, the autostaler system 102 may be implemented by (e.g., located entirely or in part on) one or more other components of the environment. For example, the autostaler system 102 may be implemented in whole or in part by the client device 108. For example, the client device 108 and/or a third-party system can download all or part of the autostaler system 102 for implementation independent of, or together with, the server(s) 104.

As further illustrated in FIG. 1, the autostaler system 102 includes server(s) 114 that house or are operated by cloud computing system 116. In particular, the cloud computing system 116 can include or manage the server(s) 114 in a distributed environment across different physical locations. The cloud computing system 116 can manage and maintain data for various applications and computational models and can further execute corresponding processes using compute instances. For instance, the cloud computing system 116 can spin up and utilize a virtual machine 118 to execute a process initiated at the client device 108 (e.g., via the client application 110). Indeed, the cloud computing system 116 can determine and allocate computing resources, such as processing capacity, storage, and memory, to perform the process at the virtual machine 118. The cloud computing system 116 can further include an autoscaling mechanism that monitors and manages compute instance and their performance across virtual machines, spinning up and spinning down virtual machines as well as modifying the processing, storage, and memory allocation attributed to the various virtual machines on a per-instance or per-process basis.

In some implementations, though not illustrated in FIG. 1, the environment may have a different arrangement of components and/or may have a different number or set of components altogether. For example, the client device 108 may communicate directly with the autostaler system 102, bypassing the network 112. As another example, the environment may include multiple client devices, each associated with a different user account. In addition, the environment can include a database located external to the server(s) 104 (e.g., in communication via the network 112) or located on the server(s) 104, the server(s) 114, and/or on the client device 108.

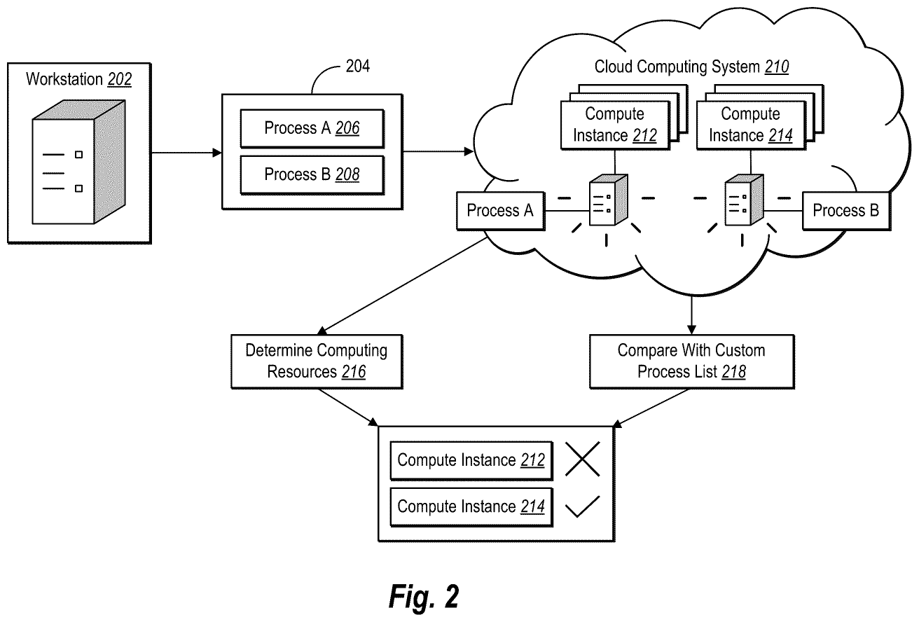

As mentioned above, the autostaler system 102 can designate compute instances as stale to prevent their termination by a cloud computing system. In particular, the autostaler system 102 can determine various metrics, features, or parameters for compute instances executed on a cloud computing system and can mark compute instances as stale based on the features/parameters. FIG. 2 illustrates an example overview of analyzing compute instances to designate stale compute instances for preservation on a virtual machine within a cloud computing system in accordance with one or more embodiments. Additional detail regarding the various acts introduced in FIG. 2 is provided thereafter in relation to subsequent figures.

As illustrated in FIG. 2, the autostaler system 102 receives or identifies one or more processes initiated at a workstation 202. Specifically, the autostaler system 102 identifies or determines that the workstation 202 has instantiated or requested performance or execution of a computational model 204 (e.g., a computer program or application for running an experiment on data). As shown, the computational model 204 includes a process A 206 and a process B 208. Indeed, the autostaler system 102 identifies process A 206 and process B 208 requested by the workstation 202 for execution on the cloud computing system 210.

As also illustrated in FIG. 2, the autostaler system 102 transmits or provides the computational model 204 (including process A 206 and process B 208) to the cloud computing system 210. In response, the cloud computing system 210 (or the autostaler system 102) determines computing resources to allocate for running the computational model 204 by executing or carrying out process A 206 and process B 208. For instance, the autostaler system 102 utilizes an autoscaling mechanism (e.g., a specially designed script or program that is part of the cloud computing system 210) to determine processing requirements, storage requirements, and/or memory requirements for a compute instance 212 executing process A 206 and for a compute instance 214 executing process B 208. In some cases, based on availability of processing, storage, and memory requirements at various servers across different physical locations, the autoscaling mechanism spins up the compute instance 212 (e.g., using one or more virtual machines) as a spot instance to execute process A 206. In a similar fashion, the autostaler system 102 spins up a compute instance 214 (e.g. using one or more virtual machines) as another spot instance to execute process B 208 (e.g., at servers in a different location than the spot instance for process A 206), even though both processes are part of the computational model 204. In some cases, the autostaler system 102 utilizes a single compute instance to execute both processes of the computational model 204.

As part of executing process A 206, the cloud computing system 210 assigns computing resources (e.g., processing power, storage, and/or memory) to the compute instance 212. The compute instance 212 then executes process A 206 by running its script or computer code. In some cases, running process A 206 takes hours, days, or weeks to complete, during which time the processing requirements for processing power, memory, and/or storage may fluctuate. At some points, the processing requirements of the compute instance 212 may dip below a threshold of the cloud computing system 210 for persisting the process and keeping the compute instance 212 assigned with its allocated resources for running process A 206. As a result of consuming less than a threshold amount of computing resources (for at least a threshold duration), the autoscaling mechanism of the cloud computing system 210 may be programmed to terminate the compute instance 212.

Similarly, as part of executing process B 208, the cloud computing system 210 assigns computing resources (e.g., processing power, storage, and/or memory) to the compute instance 214. The compute instance 214 then executes process B 208 by running its script or computer code. In some cases, running process B 208 takes hours, days, or weeks to complete, during which time the processing requirements for processing power, memory, and/or storage may fluctuate. At some points, the processing requirements may dip below a threshold of the cloud computing system 210 for persisting the process and keeping the compute instance 214 assigned with its allocated resources for running process B 208. As a result of consuming less than a threshold amount of computing resources (for at least a threshold duration), the autoscaling mechanism of the cloud computing system 210 may be programmed to terminate the compute instance 214.

As further illustrated in FIG. 2, the autostaler system 102 performs an act 216 to determine computing resources. In particular, the autostaler system 102 determines computing resources at the instance level, for the compute instance 212 and the compute instance 214. In some cases, the autostaler system 102 determines computing resources at the process level, for the process A 206 and for the process B 208. For example, the autostaler system 102 determines process A resources that include processing power, memory, storage requirements, and processing time. The autostaler system 102 further compares the computing resources of the compute instance 212 (or of the process A 206) with resource thresholds of the cloud computing system 210 to determine whether compute instance 212 (or process A 206) would be terminated by an autoscaling mechanism (e.g., if the processing power and/or memory requirements are below a threshold level for at least a threshold time). In some cases, the autostaler system 102 detects when an autoscaling mechanism of the cloud computing system 210 marks compute instance 212 (or process A 206) for termination and/or when the cloud computing system 116 determines to terminate compute instance 212 (or process A 206).

Similarly, the autostaler system 102 determines computing resources for compute instance 214 (or for process B 208) in the same way as for compute instance 212 (or process A 206). For example, the autostaler system 102 determines compute instance 214 (or process B) resources and compares the resources with resource thresholds of the cloud computing system 210 to determine whether compute instance 214 (or process B 208) would be terminated by an autoscaling mechanism (e.g., if the processing power and/or memory requirements are below a threshold level for at least a threshold time). In some cases, the autostaler system 102 detects when an autoscaling mechanism of the cloud computing system 210 marks the compute instance 214 (or process B 208) for termination and/or when the cloud computing system 116 determines to terminate compute instance 214 (or process B 208).

Additionally, the autostaler system 102 performs an act 218 to compare with a custom process list. To elaborate, the autostaler system 102 determines processes executed on or performed by the compute instance 212 and the compute instance 214, such as the process A 206 and the process B 208, respectively. In addition, the autostaler system 102 compares the process A 206 and the process B 208 with a custom process list that indicates or defines processes either marked as not terminatable or marked as terminatable. Indeed, the custom process list can act as a termination list where processes included in the list are terminatable (or are not stale-able or not persist-able), or can act as a stale-able list where processes in the list are not terminatable (or are stale-able or persist-able). In some embodiments, the autostaler system 102 generates and modifies the custom process list to add and/or remove processes over time and/or based on various metrics or factors, as discussed in further detail below. In some cases, the autostaler system 102 performs the act 218 after performing the act 216 and in response to determining that the resources for executing a compute instance and/or a process fall below one or more thresholds of the cloud computing system 210 (e.g., as an additional check to see whether the instance/process should indeed be terminated).

Based on performing the act 216 and/or the act 218, the autostaler system 102 further determines compute instances to mark or designate as stale to thereby preserve the compute instance even if the cloud computing system 116 would otherwise determine a compute instance should be terminated. Indeed, the autostaler system 102 can generate instance state data to include as part of or associated with (e.g., as a metadata tag) the compute instance 212 and/or the compute instance 214, where the instance state data designates or defines a state of a compute instance. As shown, the autostaler system 102 determines that compute instance 212 should be terminated and not marked stale. Specifically, the autostaler system 102 determines that compute instance 212 is running one or more processes within a custom process list of processes flagged as terminatable (or is not within a custom process list of process to mark as stale). As also shown, the autostaler system 102 determines that compute instance 214 should be marked as stale and therefore persisted (or not terminated). Specifically, the autostaler system 102 determines that compute instance 214 is running one or more processes not within a custom process list of processes flagged as terminatable (or is running one or processes within a custom process list of process to mark as stale).

In some embodiments, the autostaler system 102 determines to mark a compute instance as stale based on its computing resources (e.g., based on the act 216) in addition (or alternatively) to comparing with a custom process list. For example, the autostaler system 102 compares the processing power of compute instance 212 with a processing power threshold (e.g., an autostaling threshold different from a scaling threshold of the cloud computing system 210). The autostaler system 102 can further compare a memory requirement of the compute instance with a memory threshold (e.g., an autostaling threshold different from a scaling threshold of the cloud computing system 210). Likewise, the autostaler system 102 can compare processing and memory requirements of compute instance 214 with corresponding thresholds as well. In some cases, the autostaler system 102 designates a stale state for compute instance 212 or compute instance 214 based on the comparison with the thresholds. For instance, the autostaler system 102 can determine a compute instance is stale if one or both (or only if both) of the processing and memory usage satisfies its respective threshold.

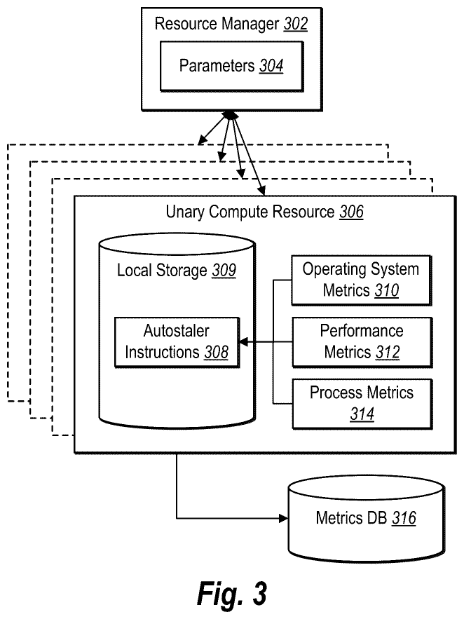

As just mentioned, in one or more embodiments, the autostaler system 102 can determine metrics associated with executing processes using compute instance on a cloud computing system. In addition, the autostaler system 102 can determine metrics or parameters indicated by comparing processes with a custom process list. The autostaler system 102 can further use the parameters and the metrics to determine whether to stale a compute instance to prevent its termination. FIG. 3 illustrates an example diagram for determining execution-related metrics and comparison-related parameters of a compute instance in accordance with one or more embodiments.

As illustrated in FIG. 3, the autostaler system 102 utilizes various scripts or software applications to run or execute a compute instance initiated at a workstation. For example, the autostaler system 102 utilizes a resource manager 302 (e.g., a hypervisor) as a script or application to determine, manage, maintain, and/or modify parameters 304 associated with a compute instance running on a cloud computing system. In some cases, the resource manager 302 includes or communicates with an autoscaling mechanism of a cloud computing system to determine and spin up (or spin down) resources for a compute instance. The resource manager 302 can include or determine the parameters 304 for the compute instance, where the parameters 304 can include scaling parameters or metrics, such as: i) the maximum (or a threshold) number of virtual machines that can be spun up (e.g., for a single compute instance or process or for a computational model or program), ii) a default number of machines that are spun up if no specific resource demands dictate a larger number, iii) a minimum number of machines to assign for a compute instance or a computational model, iv) a threshold processing power (e.g., CPU usage) for adding additional machines, v) a threshold memory usage for adding additional machines, vi) a threshold processing power for terminating a process, and vii) a threshold memory usage for terminating a compute instance. In some cases, the autostaler system 102 can utilize the resource manager 302 that is a modified version of a conventional resource manager found in prior cloud computing systems and which accounts for parameters to determine whether a compute instance is stale.

As further illustrated in FIG. 3, the autostaler system 102 utilizes a unary compute resource 306 (e.g., a compute instance) to execute one or more processes. The autostaler system 102 further determines a state for the unary compute resource 306 (or the compute instance) based on various parameters or metrics. The unary compute resource 306 can represent or refer to a compute instance that is assigned to a run a particular process (or processes) of a computational model (e.g., from a workstation). In some embodiments, the autostaler system 102 can utilize a different unary compute resource for each compute instance (or process) of a program or computational model (and/or can assign multiple unary compute resources to single compute instances (or processes) that are more computationally intensive). As shown, the unary compute resource 306 is a modified version of a conventional virtual machine that includes autostaler instructions 308 (e.g., a script or application to determine whether a process is stale) on a local storage 309 (e.g., on a client device or workstation in communication with the unary compute resource 306).

As mentioned, the autostaler system 102 can use various metrics to determine a state of the unary compute resource 306 (or the compute instance). For instance, the autostaler system 102 can determine a first state of the unary compute resource 306 that is currently running and that satisfies one or more resource thresholds (e.g., a processing threshold and/or a memory threshold) of the resource manager 302 for keeping the compute instance alive. In addition, the autostaler system 102 can determine a second state of the unary compute resource 306 that is idle and ready for termination, where an idle compute instance is one that does not satisfy one or more resource thresholds. Further, the autostaler system 102 can determine a third state of the unary compute resource 306 that is stale, even if it fails to satisfy one or more resource thresholds.

To determine a state for a compute instance, the autostaler system 102 spins up the unary compute resource 306 to include the autostaler instructions 308 and uses the autostaler instructions 308 to determine staling metrics, such as operating system metrics 310, performance metrics 312, and process metrics 314. For example, the autostaler system 102 (via the autostaler instructions 308) determines operating system metrics 310 that include current processor (e.g., CPU and/or GPU) usage of the unary compute resource 306, current memory usage of a compute instance, average processor usage of the unary compute resource 306 over a period of time, average memory usage of the unary compute resource 306 over a period of time, total processor usage of the unary compute resource 306, and/or total memory usage of the unary compute resource 306. In some embodiments, the autostaler instructions 308 include instructions to persist the unary compute resource 306 (preventing its termination) for a threshold lifespan and/or until one or more designated processes are complete.

In addition, the autostaler system 102 determines performance metrics 312 that include hard drive speed, processor temperature, and/or memory speed (e.g., read/write speed). To elaborate, the autostaler system 102 monitors, via the resource manager 302, the performance of the unary compute resource 306. For instance, the autostaler system 102 monitors metrics spun up for the unary compute resource 306 including changes made to the metrics over time (e.g., changes in speed, temperature, etc.) that impact the stale-ability of the unary compute resource 306.

Further, the autostaler system 102 determines process metrics 314 that include or indicate a comparison of processes running on the unary compute resource 306 with a custom process list. Indeed, the process metrics 314 can include binary indications of whether processes match or correspond to processes in a custom process list. In some cases, the autostaler system 102 determines or generates the custom process list as part of the process metrics 314 as well. In some embodiments, the autostaler system 102 distinguishes between backend processes (e.g., operating system processes) and user-initiated processes (e.g., non-operating system processes) as part of generating a custom process list.

For example, the autostaler system 102 generates a custom process list that includes known operating system processes that are not part of a computational model, that include no input and/or output, and/or that are terminatable without impacting a computational model (and which can therefore be marked as idle and terminated). In some cases, the autostaler system 102 generates a custom process list to also include operating system processes and/or non-operating-system processes, such as processes associated with a computer application that is irrelevant to a computational model and can me marked as idle for termination. The autostaler system 102 can perform an anomaly analysis of historical process logs associated with a user account and/or a workstation that initiates a particular compute instance (and/or other accounts/workstations within a particular group or team) to identify one or more processes previously designated as stale (according to the parameters and metrics described herein). In certain embodiments, the autostaler system 102 utilizes two process lists—an operating system process list for operating system processes and a custom process list for non-operating-system processes.

In some embodiments, the autostaler system 102 determines one or more of the staling metrics, such as the operating system metrics 310, the performance metrics 312, and/or the process metrics 314 (and/or the parameters 304) periodically at regular intervals (e.g., every one minute, every five minutes, every ten minutes) and/or based on a trigger event such as a change or update to a process (e.g., in its code or in its assignment to a virtual machine on a cloud computing system). As further shown, the autostaler system 102 can store the staling metrics (and/or the parameters 304) in a metrics database 316.

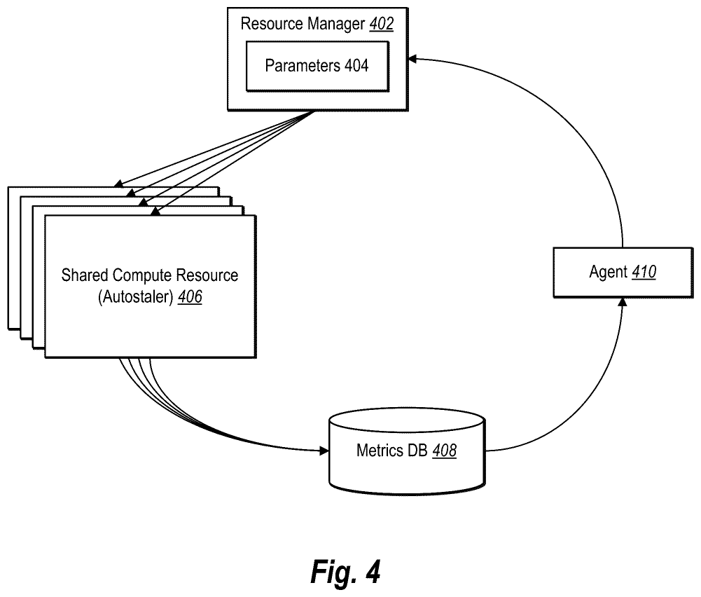

As noted above, in certain embodiments, the autostaler system 102 can generate and modify a custom process list to determine whether a compute instance should be terminated or staled. In particular, the autostaler system 102 can utilize an agent (e.g., a machine learning model or an administrator device) to update a process list (and/or other scaling/staling parameters or staling metrics) to adjust the standards for designating a compute instance as stale. FIG. 4 illustrates an example diagram for generating and modifying a custom process list (and/or other metrics) in accordance with one or more embodiments.

As illustrated in FIG. 4, the autostaler system 102 determines scaling parameters 404 for a resource manager 402 (e.g., the resource manager 302) as well as staling metrics for an autostaler mechanism 406 running on a compute instance (e.g., the unary compute resource 306) or a local workstation. The autostaler system 102 further stores both in a metrics database 408. Indeed, the autostaler system 102 determines the various parameters and metrics as described above in relation to FIG. 3.

In addition, the autostaler system 102 can utilize a feedback loop to modify a custom process list. Specifically, the autostaler system 102 can utilize an agent 410 (e.g., a script or a machine learning model such as a neural network) to generate or predict modifications for a custom process list. For example, the agent 410 can monitor various compute instances (e.g., unary compute resources), including their resource loads when running processes for a computational model and/or processes associated with other applications. Indeed, the autostaler system 102 can identify compute instances initiated by a common user account and/or by a common workstation. The autostaler system 102 can also identify compute instances running as part of a joint computational model and/or a compute instance that processes or uses data from (e.g., generated by) another compute instance. In some cases, the autostaler system 102 can also determine processes that are crucial or vital to a particular computational model (e.g., whose termination would break the computational model or else cause errors) as part of determining a custom process list.

The autostaler system 102 can also use a machine learning version of the agent 410 to generate relationship scores between processes and/or between compute instances. Indeed, based on one or more of the above factors, such as processes sharing common compute instances, processes included as part of a joint computational model, and/or processes initiated by common user accounts and/or workstations, the agent 410 can generate a predicted probability that two process (or two compute instances) are related. The autostaler system 102 can train the agent 410 on training data that includes one or more of the above factors, along with ground truth indications of relationships among processes (or compute instances). Thus, upon training, the agent 410 can predict relationship scores (e.g., probabilities) between processes or compute instances. If a relationship score satisfies a threshold, the autostaler system 102 can add one or more processes to a custom process list.

Based on one or more of such factors, the autostaler system 102 can use the agent 410 to further adjust various resource thresholds to improve performance by spinning up more resources or machines for certain processes or compute instances that have a propensity to slow down (or spinning down resources or machines for processes that are less computationally expensive). For instance, the agent 410 can adjust resource levels for compute instances based on fluctuations in the number of workstations or user accounts accessing certain shared processes.

In some cases, the autostaler system 102 (via the agent 410) can also modify a custom process list by adding or removing processes. In some cases, the autostaler system 102 can modify the custom process list based on process affiliation with particular computational models and/or generated output data. For example, as noted above, the agent 410 can determine a relationship score between a first process in a custom process list and another process not in the custom process list. A process can either be part of the computational model directly or an ancillary process running outside of, but related to, the model. Either way, the autostaler system 102 can determine to keep a compute instance running the process alive by not adding it to a custom process list for termination (e.g., according to relationship scores between the process and other processes in the custom process list not satisfying a threshold).

As another example, the autostaler system 102 can use the agent 410 to detect at least a threshold number of instances of a process across various compute instances, where the process also consumes less than a threshold processor usage and/or a threshold memory usage. Based on such determinations, the agent 410 can predict a termination score (e.g., based on training the agent 410 on training data indicating relationships between processes that are terminatable and/or not terminatable and their respective resource usage and/or frequency across virtual machines) that satisfies a termination threshold, thus indicating that the process is terminatable. Accordingly, the autostaler system 102 can use the agent 410 to modify the custom process list to include the process.

The autostaler system 102 can further repeat the processes illustrated in FIG. 4 at regular intervals (e.g., hourly, daily, every three days) and/or in response to trigger events such as changes or updates to program code (of a computational model) or detecting that a cloud computing system has marked a compute instance for termination (or is trying to terminate a process). In some embodiments, the autostaler system 102 can modify a custom process list based on cyclical or periodic data, such as predictions for when system updates occur or when new data is ingested into the genealogical data system 106 (e.g., based on a cadence or periodicity of past occurrences).

Specifically, the agent 410 can update scaling parameters and/or staling metrics to scale more quickly (and to be less stringent on resources and more likely to mark processes as stale to prevent termination) based on resource load during large system updates or large database changes (or at times where such events are predicted to occur based on training data indicating historical updates and their corresponding processes and resource utilization). Conversely, the agent 410 can update scaling parameters and/or staling metrics to scale more slowly (and to be more stringent on resources and less likely to mark processes as stale to prevent termination) based on resource load during light utilization periods (e.g., periods where the agent 410 predicts less machine activity on the cloud computing system). Metrics corresponding to higher likelihoods of marking processes as stale include lower CPU and memory thresholds for when a process is marked stale (so that lighter processes are stale-able) and/or higher instance counts of the same process across virtual machines. Metrics corresponding to lower likelihoods of marking processes as stale include higher CPU and memory thresholds for when a process is marked stale (so that processes need to be more intensive to be stale-able) and/or lower instance counts of the same process across virtual machines.

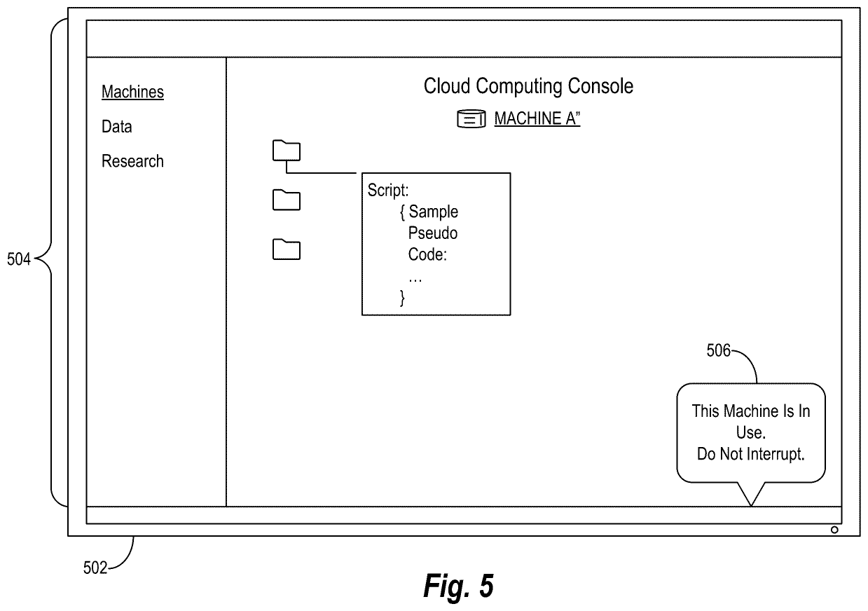

As mentioned, in certain embodiments, the autostaler system 102 can generate and provide a notification of a stale compute instance for display on a client device. In particular, the autostaler system 102 can generate a notification to prevent interruptions of a stale compute instance. FIG. 5 illustrates an example stale process notification within a graphical user interface in accordance with one or more embodiments.

As illustrated in FIG. 5, the autostaler system 102 generates and provides a graphical user interface 504 for display on a client device 502 (e.g., a workstation). Specifically, the autostaler system 102 generates a graphical user interface 504 for a data scientist to generate and run computational models via a cloud computing system. As shown, the graphical user interface 504 is a cloud computing console for running a particular compute instance as part of a program or application. In some cases, the autostaler system 102 provides the graphical user interface 504 for display in response to detecting an attempting login (or some other input) via the client device 502. Specifically, the autostaler system 102 generates and provides a stale compute instance notification 506 for display to indicate that the client device is currently working with one or more virtual machines of a stale compute instance and that the compute instance should not be interrupted (e.g., and/or that client device 502 should not be disturbed).

The components of the autostaler system 102 can include software, hardware, or both. For example, the components of the autostaler system 102 can include one or more instructions stored on a computer-readable storage medium and executable by processors of one or more computing devices. When executed by one or more processors, the computer-executable instructions of the autostaler system 102 can cause a computing device to perform the methods described herein. Alternatively, the components of the autostaler system 102 can comprise hardware, such as a special purpose processing device to perform a certain function or group of functions. Additionally or alternatively, the components of the autostaler system 102 can include a combination of computer-executable instructions and hardware.

Furthermore, the components of the autostaler system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the autostaler system 102 may be implemented as part of a stand-alone application on a personal computing device or a mobile device.

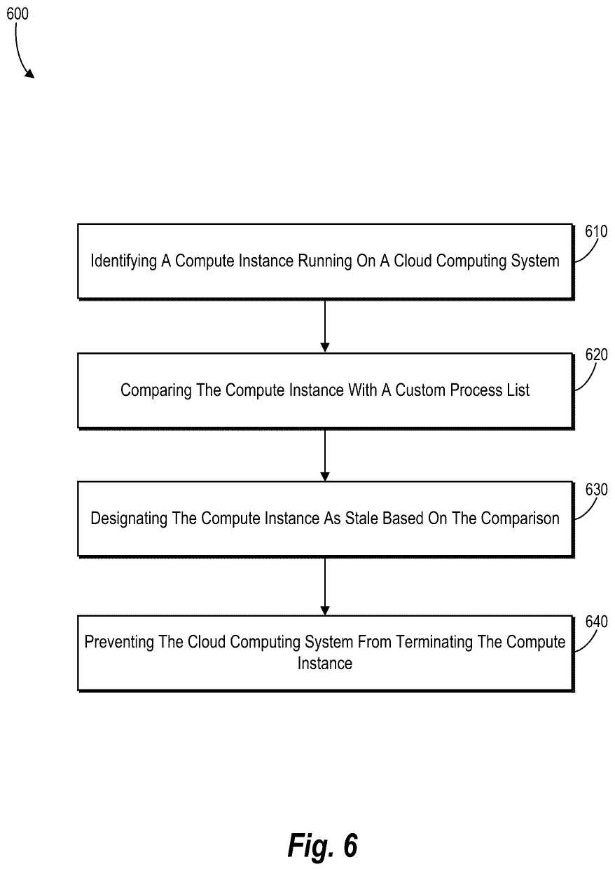

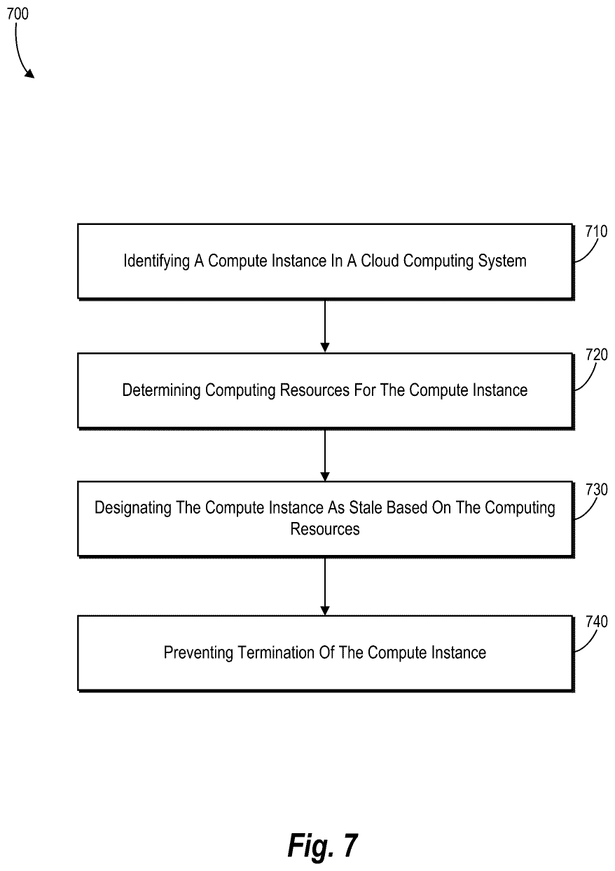

FIGS. 1-5, the corresponding text, and the examples provide a number of different systems and methods for determining and designating compute instances as stale to prevent termination within a cloud computing system based on various factors. In addition to the foregoing, implementations can also be described in terms of flowcharts comprising acts steps in a method for accomplishing a particular result. For example, FIGS. 6-7 illustrate example series of acts for determining and designating processes as stale to prevent termination within a cloud computing system in accordance with one or more embodiments.

While FIGS. 6-7 illustrate acts according to certain implementations, alternative implementations may omit, add to, reorder, and/or modify any of the acts shown in FIGS. 6-7. The acts of FIGS. 6-7 can be performed as part of a method. Alternatively, a non-transitory computer-readable medium can comprise instructions, that when executed by one or more processors, cause a computing device to perform the acts of FIGS. 6-7. In still further implementations, a system can perform the acts of FIGS. 6-7.

As illustrated in FIG. 6, the series of acts 600 includes an act 610 of identifying a compute instance running on a cloud computing system. For example, the act 610 can involve identifying a compute instance running on one or more virtual machines within a cloud computing system. In addition, the series of acts 600 includes an act 620 of comparing the compute instance with a custom process list. For example, the act 620 involves comparing a process associated with the compute instance with a custom process list comprising computer processes designated for termination. As shown, the series of acts 600 includes an act 630 of designating the compute instance as stale based on the comparison. For example, the act 630 involves designating the compute instance as stale based on comparing the process with the custom process list. Additionally, the series of acts 600 includes an act 640 of preventing the cloud computing system from terminating the compute instance. For example, the act 640 involves preventing the cloud computing system from terminating the compute instance based on designating the compute instance as stale.

In some embodiments, the series of acts 600 includes an act of generating the custom process list by: determining a set of operating system processes defining general operating system functions of an operating system on the compute instance within the cloud computing system and determining a set of additional computer processes that are not stale-able. The series of acts 600 can also include an act of determining the set of additional computer processes that are not stale-able by one or more of: determining processing expenses associated with one or more processes, analyzing process names associated with the one or more processes, or comparing the one or more processes with processes previously designated as stale.

In one or more embodiments, the series of acts 600 includes an act of, based on determining the processing expenses associated with the one or more processes, determining that a processing expense of the process associated with the compute instance does not satisfy a usage threshold for persisting processes within the cloud computing system. The series of acts 600 can include an act of determining the processes previously designated as stale by: detecting at least a threshold number of compute instances commonly running a particular process designated as stale and based on detecting at least the threshold number of compute instances commonly running the particular process, adding the particular process to a set of processes designated as stale.

In some embodiments, the series of acts 600 includes an act of determining process metrics for a plurality of processes initiated at virtual machines running on the cloud computing system and an act of modifying, based on the process metrics, the custom process list to include additional processes designated for termination. The series of acts 600 can include an act of generating modified versions of the custom process list based on changes in processes running on virtual machines in the cloud computing system and an act of periodically comparing the process with the modified versions of the custom process list.

In one or more embodiments, the series of acts 700 can include an act of designating the compute instance as stale by determining an instance state among a set of possible instance states including: a first state for compute instances marked as currently running, a second state for compute instances marked as idle and ready for termination, and a third state for compute instances marked as stale. The series of acts 600 can also include an act of terminating the compute instance after expiration of a threshold lifespan.

In some embodiments, the series of acts 600 includes an act of generating, for display on a client device interfacing with the compute instance, a notification indicating that the compute instance is stale and not to be interrupted. The series of acts 600 can also include an act of preventing the cloud computing system from terminating the compute instance by providing computer instructions to the cloud computing system to persist the compute instance. In some cases, the series of acts 600 can include an act of designating the compute instance as stale by comparing the compute instance with historical compute instances previously designated as stale within the cloud computing system. In one or more embodiments, the series of acts 600 can include an act of comparing the process running on the compute instance with processes run on the historical compute instances previously designated as stale.

FIG. 7 illustrates an example series of acts 700 for preserving a compute instance designated as stale. The series of acts 700 includes an act 710 of identifying a compute instance in a cloud computing system. For example, the act 710 involves identifying a compute instance running on one or more virtual machines within a cloud computing system. In addition, the series of acts 700 includes an act 720 of determining computing resources for the compute instance. For example, the act 720 involves determining that the compute instance consumes less a threshold usage of computing resources for persisting compute instances. In addition, the series of acts 700 includes an act 730 of designating the compute instance as stale based on the computing resources. For example, the act 730 involves designating the compute instance as stale based on determining that the compute instance consumes less than the threshold usage. Further, the series of acts 700 includes an act 740 of preventing termination of the compute instance. For example, the act 740 involves preventing the cloud computing system from terminating the compute instance based on designating the compute instance as stale.

In some embodiments, the series of acts 700 includes an act of preventing the cloud computing system from terminating the compute instance by providing computer instructions to the cloud computing system to override a termination function of the cloud computing system for compute instances that consume less than the threshold usage. In addition, the series of acts 700 can include an act of designating the compute instance as stale by generating instance state data defining a stale state for the compute instance and distinguishing from an idle state associated with other compute instances of the cloud computing system. The series of acts 700 can also include an act of identifying the compute instance as a set of cloud computing resources jointly dedicated to a function within the cloud computing system.

In one or more embodiments, the series of acts 700 includes an act of designating the compute instance as stale by: determining a process running on the compute instance within the cloud computing system, comparing the process of the compute instance with a custom process list comprising computer processes designated for termination, and based on comparing the process with the custom process list, designating the compute instance as stale to prevent termination. The series of acts 700 can also include an act of generating, for display on a client device interfacing with the compute instance, a notification indicating that the compute instance is stale.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates a block diagram of exemplary computing device 800 (e.g., the server(s) 104, the server(s) 114, and/or the client device 108) that may be configured to perform one or more of the processes described above. One will appreciate that server(s) 104 and/or the client device 108 may comprise one or more computing devices such as computing device 800. As shown by FIG. 8, computing device 800 can comprise processor 802, memory 804, storage device 806, I/O interface 808, and communication interface 810, which may be communicatively coupled by way of communication infrastructure 812. While an exemplary computing device 800 is shown in FIG. 8, the components illustrated in FIG. 8 are not intended to be limiting. Additional or alternative components may be used in other implementations. Furthermore, in certain implementations, computing device 800 can include fewer components than those shown in FIG. 8. Components of computing device 800 shown in FIG. 8 will now be described in additional detail.

In particular implementations, processor 802 includes hardware for executing instructions, such as those making up a computer program. As an example and not by way of limitation, to execute instructions, processor 802 may retrieve (or fetch) the instructions from an internal register, an internal cache, memory 804, or storage device 806 and decode and execute them. In particular implementations, processor 802 may include one or more internal caches for data, instructions, or addresses. As an example and not by way of limitation, processor 802 may include one or more instruction caches, one or more data caches, and one or more translation lookaside buffers (TLBs). Instructions in the instruction caches may be copies of instructions in memory 804 or storage device 806.

Memory 804 may be used for storing data, metadata, and programs for execution by the processor(s). Memory 804 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 804 may be internal or distributed memory.

Storage device 806 includes storage for storing data or instructions. As an example and not by way of limitation, storage device 806 can comprise a non-transitory storage medium described above. Storage device 806 may include a hard disk drive (HDD), a floppy disk drive, flash memory, an optical disc, a magneto-optical disc, magnetic tape, or a Universal Serial Bus (USB) drive or a combination of two or more of these. Storage device 806 may include removable or non-removable (or fixed) media, where appropriate. Storage device 806 may be internal or external to computing device 800. In particular implementations, storage device 806 is non-volatile, solid-state memory. In other implementations, Storage device 806 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 808 allows a user to provide input to, receive output from, and otherwise transfer data to and receive data from computing device 800. I/O interface 808 may include a mouse, a keypad or a keyboard, a touch screen, a camera, an optical scanner, network interface, modem, other known I/O devices or a combination of such I/O interfaces. I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 808 is configured to provide graphical data to a display for presentation to a user. The graphical data may be representative of one or more graphical user interfaces and/or any other graphical content as may serve a particular implementation.

Communication interface 810 can include hardware, software, or both. In any event, communication interface 810 can provide one or more interfaces for communication (such as, for example, packet-based communication) between computing device 800 and one or more other computing devices or networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 810 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 810 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 810 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 812 may include hardware, software, or both that couples components of computing device 800 to each other. As an example and not by way of limitation, communication infrastructure 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 9 is a schematic diagram illustrating environment 900 within which one or more implementations of the autostaler system 102 can be implemented. For example, the autostaler system 102 may be part of a genealogical data system 902 (e.g., the genealogical data system 106). The genealogical data system 902 may generate, store, manage, receive, and send digital content (such as genealogical content items). For example, genealogical data system 902 may send and receive digital content to and from client devices 906 by way of network 904. In particular, genealogical data system 902 can store and manage genealogical databases for various user accounts, historical records, and genealogy trees. In some embodiments, the genealogical data system 902 can manage the distribution and sharing of digital content between computing devices associated with user accounts. For instance, the genealogical data system 902 can facilitate a user account sharing a genealogical content item with another user account of genealogical data system 902.

In particular, the genealogical data system 902 can manage synchronizing digital content across multiple client devices 906 associated with one or more user accounts. For example, a user may edit a digitized historical document or a node within a genealogy tree using client device 906. The genealogical data system 902 can cause client device 906 to send the edited genealogical content to the genealogical data system 902, whereupon the genealogical data system 902 synchronizes the genealogical content on one or more additional computing devices.

As shown, the client device 906 may be a desktop computer, a laptop computer, a tablet computer, an augmented reality device, a virtual reality device, a personal digital assistant (PDA), an in-or out-of-car navigation system, a handheld device, a smart phone or other cellular or mobile phone, or a mobile gaming device, other mobile device, or other suitable computing devices. The client device 906 may execute one or more client applications, such as a web browser (e.g., Microsoft Windows Internet Explorer, Mozilla Firefox, Apple Safari, Google Chrome, Opera, etc.) or a native or special-purpose client application (e.g., Ancestry: Family History & DNA for iPhone or iPad, Ancestry: Family History & DNA for Android, etc.), to access and view content over the network 904.

The network 904 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 906 may access genealogical data system 902.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
identifying a compute instance running on one or more virtual machines within a cloud computing system;
comparing a process associated with the compute instance with a custom process list comprising computer processes designated for termination;
designating the compute instance as stale based on comparing the process with the custom process list; and
preventing the cloud computing system from terminating the compute instance based on designating the compute instance as stale.

2. The computer-implemented method of claim 1, further comprising generating the custom process list by:
determining a set of operating system processes defining general operating system functions of an operating system on the compute instance within the cloud computing system; and
determining a set of additional computer processes that are not stale-able.

3. The computer-implemented method of claim 2, wherein determining the set of additional computer processes that are not stale-able comprises one or more of:
determining processing expenses associated with one or more processes;
analyzing process names associated with the one or more processes; or
comparing the one or more processes with processes previously designated as stale.

4. The computer-implemented method of claim 3, further comprising, based on determining the processing expenses associated with the one or more processes, determining that a processing expense of the process associated with the compute instance does not satisfy a usage threshold for persisting processes within the cloud computing system.

5. The computer-implemented method of claim 3, further comprising determining the processes previously designated as stale by:
detecting at least a threshold number of compute instances commonly running a particular process designated as stale; and
based on detecting at least the threshold number of compute instances commonly running the particular process, adding the particular process to a set of processes designated as stale.

6. The computer-implemented method of claim 1, further comprising:
determining process metrics for a plurality of processes initiated at virtual machines running on the cloud computing system; and
modifying, based on the process metrics, the custom process list to include additional processes designated for termination.

7. The computer-implemented method of claim 1, further comprising:
generating modified versions of the custom process list based on changes in processes running on virtual machines in the cloud computing system; and
periodically comparing the process with the modified versions of the custom process list.

8. A non-transitory computer readable medium storing instructions which, when executed by at least one processor, cause the at least one processor to:
identify a compute instance running within a cloud computing system;
compare a process associated with the compute instance with a custom process list comprising computer processes designated for termination;
designate the compute instance as stale based on comparing the process with the custom process list; and
prevent the cloud computing system from terminating the compute instance based on designating the compute instance as stale.

9. The non-transitory computer readable medium of claim 8, further comprising instructions which, when executed by the at least one processor, cause the at least one processor to designate the compute instance as stale by determining an instance state among a set of possible instance states comprising:
a first state for compute instances marked as currently running;
a second state for compute instances marked as idle and ready for termination; and
a third state for compute instances marked as stale.

10. The non-transitory computer readable medium of claim 8, further comprising instructions which, when executed by the at least one processor, cause the at least one processor to terminate the compute instance after expiration of a threshold lifespan.

11. The non-transitory computer readable medium of claim 8, further comprising instructions which, when executed by the at least one processor, cause the at least one processor to generate, for display on a client device interfacing with the compute instance, a notification indicating that the compute instance is stale and not to be interrupted.

12. The non-transitory computer readable medium of claim 8, further comprising instructions which, when executed by the at least one processor, cause the at least one processor to prevent the cloud computing system from terminating the compute instance by providing computer instructions to the cloud computing system to persist the compute instance.

13. The non-transitory computer readable medium of claim 8, further comprising instructions which, when executed by the at least one processor, cause the at least one processor to designate the compute instance as stale by comparing the compute instance with historical compute instances previously designated as stale within the cloud computing system.

14. The non-transitory computer readable medium of claim 13, wherein comparing the compute instance with historical compute instances comprises comparing the process running on the compute instance with processes run on the historical compute instances previously designated as stale.

15. A system comprising:
one or more memory devices; and
one or more processors coupled to the one or more memory devices, wherein the one or more processors are configured to cause the system to:
identify a compute instance running on one or more virtual machines within a cloud computing system;
determine that the compute instance consumes less a threshold usage of computing resources for persisting compute instances;
designate the compute instance as stale based on determining that the compute instance consumes less than the threshold usage; and
prevent the cloud computing system from terminating the compute instance based on designating the compute instance as stale.

16. The system of claim 15, wherein the one or more processors are further configured to cause the system to prevent the cloud computing system from terminating the compute instance by providing computer instructions to the cloud computing system to override a termination function of the cloud computing system for compute instances that consume less than the threshold usage.

17. The system of claim 15, wherein the one or more processors are further configured to cause the system to designate the compute instance as stale by generating instance state data defining a stale state for the compute instance and distinguishing from an idle state associated with other compute instances of the cloud computing system.

18. The system of claim 15, wherein the one or more processors are further configured to cause the system to identify the compute instance as a set of cloud computing resources jointly dedicated to a function within the cloud computing system.

19. The system of claim 15, wherein the one or more processors are further configured to cause the system to designate the compute instance as stale by:
determining a process running on the compute instance within the cloud computing system;
comparing the process of the compute instance with a custom process list comprising computer processes designated for termination; and
based on comparing the process with the custom process list, designating the compute instance as stale to prevent termination.

20. The system of claim 15, wherein the one or more processors are further configured to cause the system to generate, for display on a client device interfacing with the compute instance, a notification indicating that the compute instance is stale.
